(19) United States
(12) Patent Application Publication
(10) Pub. No.: US 2009/0183502 A1
(43) Pub. Date: Jul. 23, 2009

(54) EXHAUST PIPE

(75) Inventor: Vincent Leroy, Montbeliard (FR)

Correspondence Address: YOUNG & THOMPSON, 209 Madison Street, Suite 500, ALEXANDRIA, VA, 22314, US

(73) Assignee: FAURECIA SYSTEMES D'ECHAPPEMENT, Nanterre (FR)

(21) Appl. No.: 12/063,482

(22) PCT Filed: Aug. 3, 2006
(86) PCT No.: PCT/FR2006/001896

§ 371 Date: Mar. 3, 2009

(30) Foreign Application Priority Data
Aug. 9, 2005 (FR) 0508466

(51) Int. Cl. F01N 7/10; F16L 9/14

(52) U.S. Cl. 60/323; 138/149

(57) ABSTRACT

The invention relates to an exhaust pipe (20) comprising the following elements which are disposed concentrically, namely: an inner tube which is made from an inorganic matrix composite (22); an outer metal tube (24); and a support layer (26) which is made from a fibrous material. The thickness of the support layer (26) measures between 2 mm and 10 mm and preferably between 3 mm and 6 mm. The maximum support pressure exerted by the support layer (26) on the inner tube (22) is between 10⁻⁴ MPa and 10⁻¹ MPa.

The present invention relates to an exhaust pipe comprising the following elements which are disposed concentrically, namely:

an inner tube which is made from an inorganic matrix composite;

a metal outer tube; and

a support layer which is made from a fibrous material.

Nowadays, the installation of depollution devices in exhaust lines requires a precise management of the thermal flows from the engine to the exhaust outlet. In particular, the essential part of the heat produced by the engine should be allowed to reach the depollution equipment installed on the exhaust line. This transfer is required particularly when starting the vehicle in order to enable the catalytic elements quickly to rise in temperature. In fact, they will not operate until they reach a pre-set temperature.

In order to enable a rapid rise in temperature of the catalyser, it is known that the elements of the exhaust line between the engine outlet and the depollution devices comprise a ceramic inner tube surrounded by a metal outer tube with an insulating material interposed. In fact, the ceramic tube, due to its low thermal inertia, considerably reduces the thermal transfer of the exhaust gases towards the ceramic tube.

Moreover, the low thermal expansion of the ceramic inner tube allows single-piece inner pipes to be made even for engines that generate exhaust gases at very high temperatures, notably higher than 1000° C. without the risk of thermo-mechanical rupture.

Such a structure is used notably in exhaust manifolds located immediately at the engine outlet.

Such a manifold is described for example in Document U.S. Pat. No. 6,725,658.

In this document, it is proposed to provide between the dense ceramic inner tube and the metal outer tube a relatively thick, thermally insulating layer of ceramic fibres in contact with the ceramic tube. The thick layer of ceramic fibres has a thickness of between 1 mm and 40 mm and preferably between 2 mm and 20 mm.

In one particular embodiment, a thin layer known as a stress-insulation layer is provided between the thick layer of ceramic fibres and the metal outer tube. This thin stress-insulation layer measures between 0.05 mm and 2 mm and preferably between 0.1 mm and 0.5 mm. This stress-insulation layer is designed to absorb the vibrations of the engine and the road in order to prevent the destruction of the thick layer of ceramic fibres. This layer also dampens vibrations, notably by compensating for the differential thermal expansions between the thick layer of ceramic fibres and the metal outer tube when the exhaust line becomes hot. In fact, when high-temperature gases pass through the inner tube, considerable differential thermal expansions are observed because the dense ceramic inner tube as well as the thick layer of ceramic fibres have relatively low coefficients of expansion in comparison with the metal outer tube.

This thin stress-insulation layer is necessary in the device described in U.S. Pat. No. 6,725,658 because the thick layer of ceramic fibres does not have the required properties to take up the clearance due the differential expansion between the dense ceramic inner tube and the metal outer tube.

U.S. Pat. No. 6,725,658 describes a multi-layer structure comprising at least one dense ceramic inner layer, one thick thermally-insulating layer of ceramic fibres and one metal layer. This structure may be completed by a thin stress-insulation layer designed to protect the thick layer of ceramic fibres from vibration.

Now, in addition to the likelihood of vibrations damaging the thick layer of ceramic fibres, a structure of the type described in U.S. Pat. No. 6,725,658 is still subjected, at the level of the inner wall of the dense ceramic inner tube, to stresses due to the flow of exhaust gases. These stresses tend to drive the inner tube along with the flow of gas causing a problem of retaining the ceramic inner tube inside the metal outer tube.

Now, the teaching of U.S. Pat. No. 6,725,658 contains no element likely to solve the problem of retaining the dense ceramic inner layer inside a metal structure.

This is why the invention relates to an exhaust pipe enabling a satisfactory routing of the heat comprising an inner tube which is made from an inorganic matrix composite retained in an outer metal structure.

For this purpose, the invention relates to an exhaust pipe of the above-mentioned type, characterised in that the thickness of the retaining layer measures between 2 mm and 10 mm, and preferably between 3 mm and 6 mm, and in that the minimum retaining pressure exerted by the retaining layer on the inner tube is between 10⁻⁴ MPa and 10⁻¹ MPa.

According to particular embodiments, the pipe described below has one or more of the following characteristics:
the minimum retaining pressure exerted by the retaining layer on the inner tube is between 10⁻³ MPa and 5·10⁻² MPa;
the metal outer tube is between 0.5 mm and 3 mm thick;
the metal outer tube is chosen from the group consisting of a steel tube, an aluminium tube and a titanium tube;
the outer tube is formed of two half-shells in the form of gutters assembled by means of longitudinal joints;
the inner tube which is made from an inorganic matrix composite is less than 2 mm thick;
the inner tube which is made from an inorganic matrix composite comprises a matrix consisting of at least one inorganic polymer;
the inorganic polymer is an aluminosilicate-based geopolymer;
the inner tube which is made from an inorganic matrix composite comprises a matrix reinforced by fibres, notably based on silicium carbide (SiC), carbon, silica (SiO₂), or a corrosion-resistant metal wire resistant to temperatures of 600° C. or more;
the retaining layer comprises a sheet of ceramic fibres;
the retaining layer comprises ceramic fibres and an inorganic binder, the retaining layer comprising between 90% and 100% ceramic fibres by weight;
the ceramic fibres are fibres selected from the group consisting of silica fibres, alumina fibres, zirconium fibres, alumina-borosilicate fibres, and mixtures thereof;
the fibres contained in the retaining layer are a mixture of alumina fibres and silica fibres in a ratio of 72 and 28% respectively;
the GBD (gap bulk density) of the material comprising the retaining layer measures between 0.1 and 0.6;
the density of the material comprising the retaining layer is between 500 g/m² and 3000 g/m²;
the friction coefficient of the material forming the retaining layer against the surfaces of the inner and outer tubes measures between 0.15 and 0.7;
the exhaust manifold has at least one exhaust pipe as defined above.

Further features and advantages of the invention will emerge from the following description, given purely by way of example, and referring to the drawings in which:

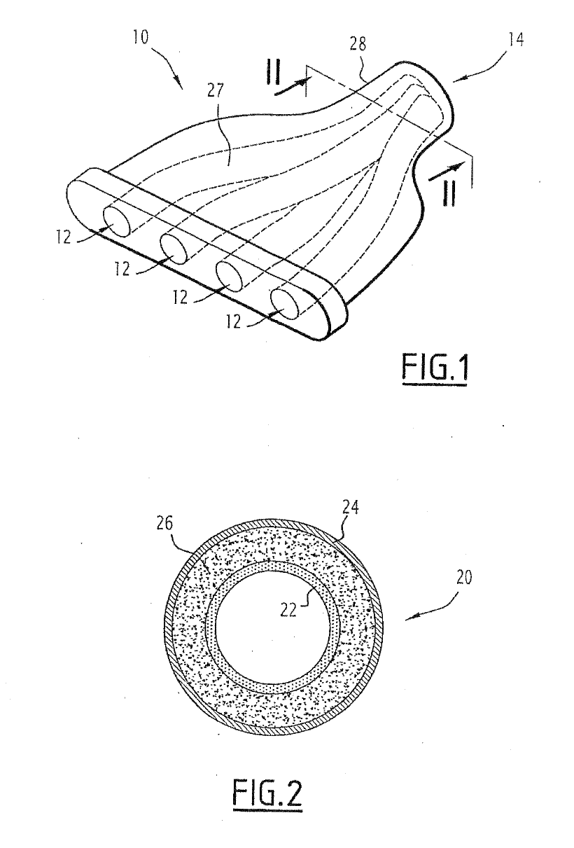

FIG. 1 is a perspective view of an exhaust manifold according to the invention; and

FIG. 2 is a cross-section of an exhaust pipe of the manifold shown in FIG. 1.

The exhaust manifold 10 shown in FIG. 1 is intended to be positioned at the outlet of a thermal engine on the inlet of an exhaust line of a motor vehicle. Downstream of the manifold 10, this exhaust line may comprise a turbocharged system and one or more depollution devices suitable for operation at high temperature.

The manifold 10 comprises several inlets 12 converging towards an outlet flange 14. The inlets 12 are connected to the outlet flange 14 by pipes 20 each running into each other.

As shown in FIG. 2, each pipe 20 has one inner tube 22 which is made from an inorganic matrix composite, notably ceramic, and one metal outer tube 24 between which one retaining layer 26 comprising a ceramic fibrous material is arranged.

Preferably, the pipe comprises only three layers 22, 24 and 26.

The outer tube 24 is formed of a metal wall having a thickness between 0.5 and 3 mm. According to a first embodiment, the outer tube 24 is a cylindrical tube made of metal, in particular, steel, aluminium or titanium.

In a variation, and as shown in FIG. 1, the outer tube 24 is formed of two metal half shells 27 in the form of gutters assembled by means of opposing longitudinal joints 28.

At each of its ends, the outer tube 24 has flanges enabling its connection, upstream, to the engine and, downstream, to the vehicle's exhaust line.

The decision to opt for a metal outer tube is justified by the need to ensure an optimum seal upstream of the depollution devices, and notably at the level of the connection of the outer tube with the metal flanges upstream and downstream. As an indication, the authorised leak rate is 25 litres/hour, at 20° C. below 1.3 bar. The inner tube 22 is a tube formed from an inorganic matrix composite material, notably ceramic. Examples of inorganic matrix composite materials that enable the formation of an inner tube 22 are given in U.S. Pat. No. 6,134,881 and WO2004106705. These materials are formed by the association of a matrix comprising at least one inorganic polymer, preferably of the geopolymer type, with an alumina-silicate base. This matrix is reinforced by fibres, notably based on silicium carbide (SiC) or carbon or silica (SiO2), or even a corrosion-resistant metal wire resistant to temperatures of 600° C. or more (stainless steel, Inconel®, etc.). Preferably, the inner tube 22 is formed of a wall less than 2 mm thick.

The retaining layer 26 is between 2 and 10 mm thick, preferably between 3 and 6 mm.

The retaining layer 26 is formed of a sheet of ceramic fibres, notably long ceramic fibres preferably combined with an organic and/or inorganic binder.

The organic binder is useful only when fitting the retaining layer around the inner tube; it is consumed on the first rise in temperature of the exhaust pipe on the vehicle. This binder represents from 0 to 15% by mass of the new retaining layer.

The inorganic binder is used when it is necessary to ensure a better cohesion between the fibres during operation of the vehicle and must not therefore be consumed. This binder represents from 0 to 10% by mass of the retaining layer excluding the organic binder.

Thus in the operating configuration, the ceramic fibres represent 90 to 100% by weight of the retaining layer, any remainder being the inorganic binder.

The ceramic fibres present in the retaining layer 26 are selected from the group consisting of silica fibres, alumina fibres, zirconium fibres, alumina borosilicate fibres and a mixture thereof. The sheets may be needle-bonded, which improves their useful lifetime.

Preferably, the fibres used are mullite fibres combining alumina and silica in a ratio of 72% and 28% respectively.

The density of the material comprising the retaining layer is between 500 g/m² and 3000 g/m².

This retaining layer 26 must ensure that the inner tube 22 is retained in the outer tube 24 whatever the operating conditions.

The minimum pressure to be applied in order to retain the said inner tube in the metal tube is calculated on the basis of the characteristics of the ceramic inner tube and the nature of the retaining layer (mass, contact surface with the retaining layer), the maximum acceleration to which it is subjected and the maximum flow and pressure of the exhaust gases. In addition to the stresses referred to above, this minimum pressure takes into account a specific correction factor of the behaviour during operation of the inner ceramic tube and the retaining layer. A friction coefficient affects this correction factor. Depending on the material comprising the inner and outer tubes, the material comprising the retaining layer is chosen so that the friction coefficient of the damping layer between the surfaces of the inner and outer tubes is between 0.15 and 0.7. The minimum retaining pressure is between 10⁻⁴ and 10⁻¹ MPa and preferably between 10⁻³ MPa and 5·10⁻² MPa.

The value of 10⁻³ MPa corresponds to an inner tube of 100 grams having a contact surface of 40 dm² with the retaining layer subjected to an acceleration of 10 g and a pressure drop of 100 Pa. This pressure drop is caused by the friction of the gases against the wall of the inner tube. The value of 5·10⁻² MPa corresponds to an inner tube of 200 grams having a contact surface of 20 dm² with the retaining layer and subjected to an acceleration of 40 g and pressure drop of 250 Pa.

It has been observed that, depending on the type of sheet chosen to comprise the retaining layer 26, it is necessary, on the one hand, to prevent the destruction of the fibres comprising the sheet and, on the other hand, to prevent damage to the inner tube made of inorganic matrix composite. For this reason, it is essential not to exceed a certain pressure exerted on the inner tube and thus a specific compression of the sheet: this maximum pressure is between 0.1 and 1 MPa and preferably between 0.3 and 0.7 MPa.

The GBD is the relationship between the density in kilograms per square metre of the sheet selected to comprise the retaining layer and the clearance in millimetres between the outer and inner tube. The density is a characteristic peculiar to the sheet. Within the scope of the invention, the value of the clearance between the outer and inner tube is dictated chiefly by the restrictions of the form of the exhaust line element. The range of useable GBD is between 0.1 and 0.6. The minimum value is given in order to prevent damage to the fibres by vibration and the maximum value is given to prevent damage to the fibres by compression.

The relationship between the GBD and the pressure P exerted on the inner tube by the retaining layer is given, for a sheet comprising long ceramic fibres, by an equation such as P=A·(GBD)³+B·(GBD)²+C(GBD)+D.

When choosing a sheet of a given density designed to ensure that the inner tube is kept separate from the outer tube by a given clearance, it must be ensured that the pressure exerted shall be greater than the minimum retaining pressure and less than the maximum pressure withstood by the fibres and the inner tube. For this reason, the fact that, during use, the clearance between the inner tube and the outer tube may vary by more or less than 1 mm depending on the differential expansion between the inner tube and the outer tube must also be taken into account.

Thus, for a retaining layer 26 formed from one sheet comprising long ceramic fibres of a density of 900 g/m², placed between an inner tube (composite pipe of 200 grams having a contact surface of 20 dm² with the retaining sheet and subjected to an acceleration of 40 g) and an outer tube separated by a minimum clearance of 3 mm, the GBD is 0.3. The retaining pressure exerted by the sheet on the inner tube made of ceramic matrix composite is thus, for the type of sheet chosen, 0.2 MPa. This GBD of 0.3 is well within the recommended GBD range. This pressure is higher than the minimum retaining pressure calculated for this application (5·10⁻² MPa) and less than the mechanical strength of the inner tube.

The maximum clearance for this same application is 4.25 mm, corresponding to a GBD of 0.22 and a retaining pressure of 6·10⁻² MPa. The GBD remains within the usable range of the sheet and the induced pressure remains higher than the minimum retaining pressure.

It will be noted that with such an exhaust pipe, the retaining material ensures that the inner tube made of inorganic matrix composite is properly retained in the outer metal tube whatever the temperature of the exhaust line and the conditions of gas flow and acceleration to which the inner tube is subjected without deterioration of or damage to the inner tube.

1-17. (canceled)

18. Exhaust pipe comprising the following elements which are disposed concentrically, namely:
an inner tube which is made from an inorganic matrix composite;
a metal outer tube;
a support layer which is made from a fibrous material, characterised in that the thickness of the retaining layer is between 2 mm and 10 mm, and preferably between 3 mm and 6 mm, and in that the minimum retaining pressure exerted by the retaining layer on the inner tube is between 10⁻⁴ MPa and 10⁻¹ MPa.

19. Pipe according to claim 18, characterised in that the minimum retaining pressure exerted by the retaining layer on the inner tube is between 10⁻³ MPa and 5·10⁻² MPa.

20. Pipe according to claim 18, characterised in that the metal outer tube is between 0.5 mm and 3 mm thick.

21. Pipe according to claim 18, characterised in that the metal outer tube is chosen from the group consisting of a steel tube, an aluminium tube and a titanium tube.

22. Pipe according to claim 18, characterised in that the outer tube is formed of two half-shells in the form of gutters assembled by means of longitudinal joints.

23. Pipe according to claim 18, characterised in that the inner tube which is made from an inorganic matrix composite is less than 2 mm thick.

24. Pipe according to claim 18, characterised in that the inner tube which is made from an inorganic matrix composite comprises a matrix consisting of at least one inorganic polymer.

25. Pipe according to claim 24, characterised in that the inorganic polymer is an aluminosilicate-based geopolymer.

26. Pipe according to claim 18, characterised in that the inner tube which is made from an inorganic matrix composite comprises a matrix reinforced by fibres, notably based on silicium carbide (SiC), carbon, silica (SiO₂), or a corrosion-resistant metal wire resistant to temperatures of 600° C. or more.

27. Pipe according to claim 18, characterised in that the retaining layer comprises a sheet of ceramic fibres.

28. Pipe according to claim 18, characterised in that the retaining layer (26) comprises ceramic fibres and an inorganic binder, the retaining layer comprising between 90% and 100% ceramic fibres by weight

29. Pipe according to claim 28, characterised in that the ceramic fibres are fibres selected from the group consisting of silica fibres, alumina fibres, zirconium fibres, alumina-borosilicate fibres, and mixtures thereof.

30. Pipe according to claim 29, characterised in that the fibres contained in the retaining layer are a mixture of alumina fibres and silica fibres in a ratio of 72 and 28% respectively.

31. Pipe according to claim 18, characterised in that the GBD of the material comprising the retaining layer measures between 0.1 and 0.6.

32. Pipe according to claim 18, characterised in that the density of the material comprising the retaining layer is between 500 g/m² and 3000 g/m².

33. Pipe according to claim 18, characterised in that the friction coefficient of the material forming the retaining layer against the surfaces of the inner and outer tubes measures between 0.15 and 0.7.

34. Exhaust manifold having at least one exhaust pipe according to claim 18.
